(19) United States
(12) Patent Application Publication
(10) Pub. No.: US 2007/0080023 A1
(43) Pub. Date: Apr. 12, 2007

(54) Arrow holder

(76) Inventor: Michael Matheny, Gainesville, GA (US)

Correspondence Address: LAW OFFICE OF L. JACK GIBNEY, 8777 SAN JOSE BLVD., SUITE 502, JACKSONVILLE, FL, 32217, US

(21) Appl. No.: 11/245,380

(22) Filed: Oct. 6, 2005

(51) Int. Cl. A01M 31/00

(52) U.S. Cl. 182/187

(57) ABSTRACT

This is a device, which will allow a quiver of arrows to be secured to a tree stand but will also allow portability of the quiver in case the individual moves. It will allow the quiver to rotate 360 degrees for appropriate positioning relative to the particular hunter.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

This relates to positioning arrows for hunting purposes. Often times it is imperative that the hunter have easy access to the arrow for hunting purposes. This device accomplishes that goal and will serve to accommodate all types of arrows.

B. Prior Art

There are many other references in the prior art related to arrow rests or arrow stands particularly with regard to tree stands. Representative examples of this type of art are described in Stepney U.S. Pat. No. 5,941,484, Proctor U.S. Pat. No. 6,672,299 and Ruble U.S. Pat. No. 5,690,088.

While all of these prior references seek to position arrows, the structure is completely different than the application in this case.

### BRIEF SUMMARY OF THE INVENTION

This device attaches to the tree stand and allows a hunter to place the quiver filled with arrows in the device to insure easy access for the hunter. Tree stands are commonly used during hunting. The hunter positions himself or herself a distance off the ground to view the hunting area and stands or sits in the tree stand while waiting for the animals to appear.

This device assists the hunter by positioning a quiver of arrows within close proximity of the hunter and the device can be rotated 360 degrees without removing it from the tree stand. The base of the device is attached to the tree stand and can be separated from the attachment in the event that the quiver of arrows needs to be moved a distance from the tree stand. The device has an insert for attaching to round or square tubing tree stands.

It is an object of this particular device to make arrows available to the hunter without having to shift the body of the hunter or bow to retrieve the arrow.

It is a further object of this device to be able to rotate the arrows to the most advantageous position that the hunter deems necessary such as standing, sitting or to the left or right of the hunter.

### BRIEF DESCRIPTION OF THE DRAWINGS

FIG. 1 is an exploded isometric view of the device.

FIG. 2 is an isometric view of the device installed with the quiver shown by the phantom figure.

FIG. 3 is a front view of the tree stand connection member of the device.

FIG. 4 is a top view of the device with an exploded view of the connection member.

FIG. 5 is a depiction of the insert for square tubing.

FIG. 6 is a depiction of the insert for round tubing.

FIG. 7 is a side view of the quiver connection member of the device.

FIG. 8 is a front view of the connection member of the device.

FIG. 9 is a front view of the tree stand connection member with the depiction for the mounting bracket shaft casing shown by the dotted lines.

### REFERENCE NUMBERS

5 Device
8 Quiver
10 Quiver bracket
15 Quiver connection member
16 Holes in mounting bracket shaft casing
17 Mounting bracket shaft casing
18 First end of the tree stand connection device
19 Insert for the tree stand
20 Second end of the tree stand connection device
21 Means of attachment for the tree stand connection device
22 Means of securement to quiver
24 Spring loaded grommet with protrusions
25 Insert for square tubing
30 Insert for round tubing
32 Grooves
33 Notches

### DETAILED DESCRIPTION OF THE EMBODIMENT

This device 5 will allow a hunter to insert a quiver 8 of arrows in the most convenient position during hunting while the hunter is in the tree stand. Tree stands are frequently used during hunting to elevate the hunter off the ground so that the hunter gets a clear view of the hunting area.

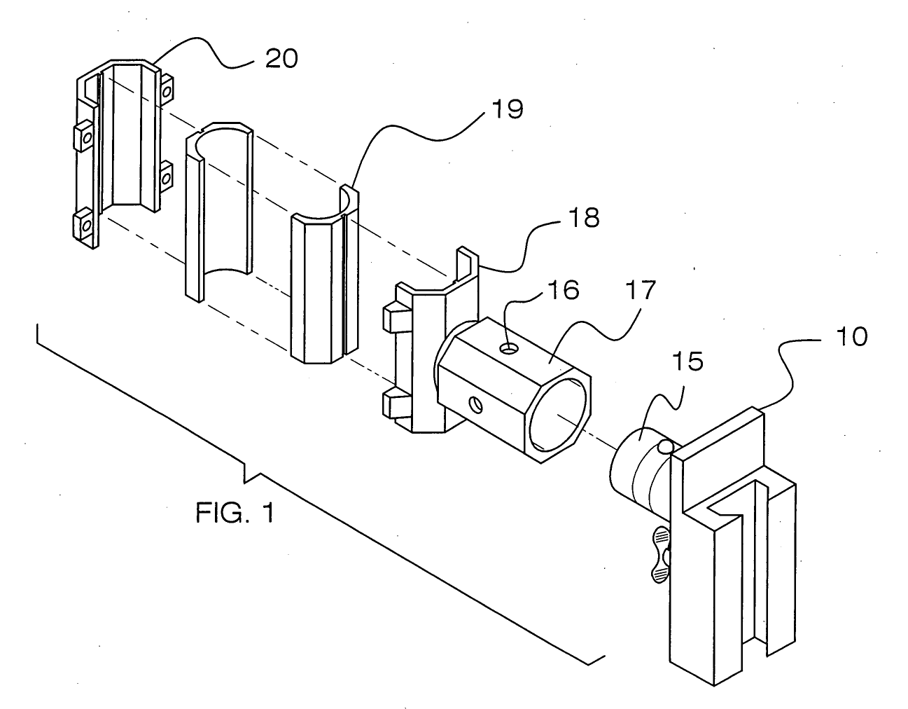

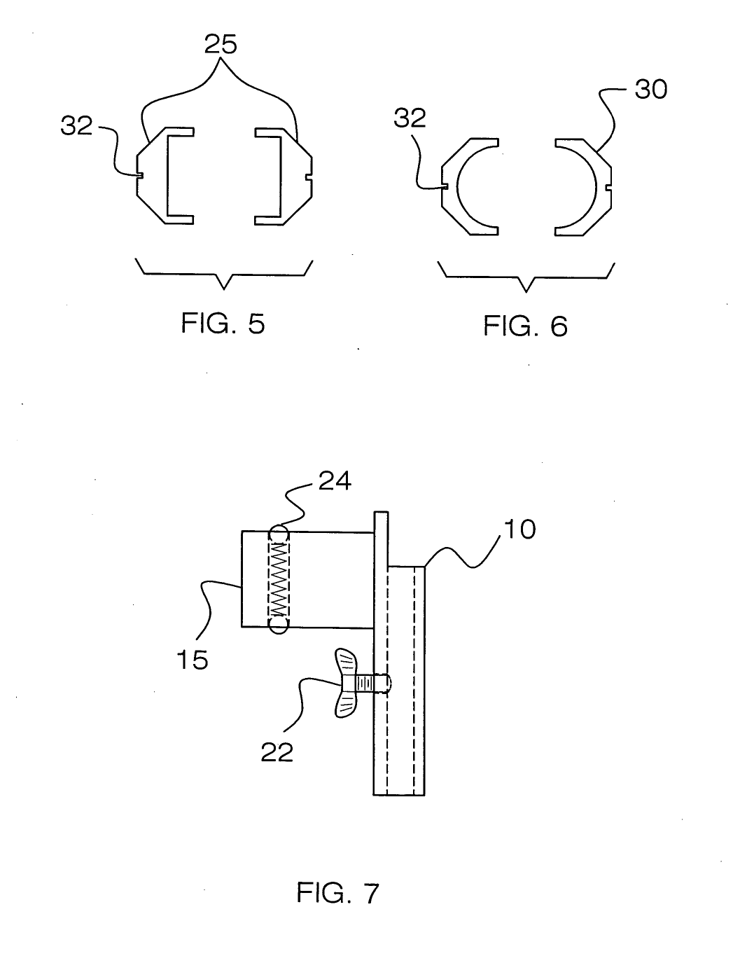

It will accommodate both inserts for square tubing 25 and round tubing 30 depending on the particular tree stand. Figure 5, 6 The device 5 will be attached to the tree stand using a tree stand connection device, which has two sides, 18, 20. FIG. 1

The tree stand fits with the square 25 or round 30 tubing at one end and the quiver 8 is at the opposite end of the device. The part of the tree stand connection device 20 is equipped with flanged members to secure that half 20 to the corresponding mating half 18 of the tree stand connection device. A means of attachment 22 is provided to join the halves. The means of attachment 22 could include allen screws, a nut and bolt or any other means of connection including a wing nut. FIG. 4

The tree stand is placed within the insert 19 and is attached to both halves 18,20 of the tree stand connection device and secured using the means of connection. FIG. 1, 4 The tree stand connection device consists of two mating parts with protrusions on the outer edges, which allow for mounting of the device around the insert 25 or 30 of the tree stand.

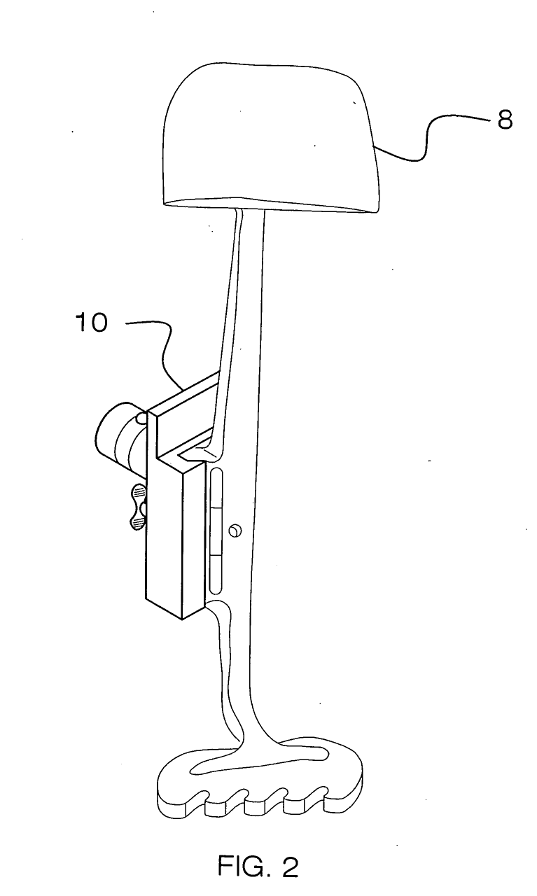

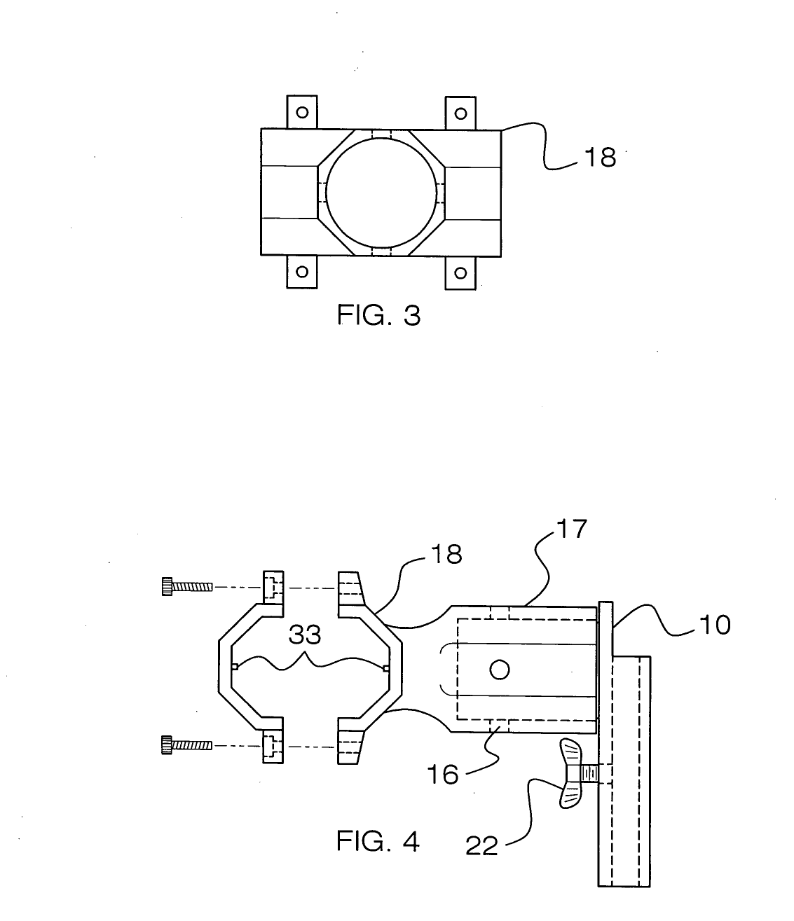

One half of the tree stand connection device 18 is equipped with a shaft 17 with a plurality of holes 16. FIG. 1, 4 This shaft 17 fits over a corresponding quiver shaft 15. FIG. 1, 4 The quiver shaft 15 is connected to a bracket 10, which holds the quiver 8. FIG. 2 The quiver 8 is secured to the bracket 10 using a means of securement 22 such as a wing nut or thumb screw. FIG. 4 This means of securement 22 will maintain the appropriate position of the quiver 8 relative to the hunter.

A spring loaded grommet with protrusions 24 will be installed through the holes 16 in the quiver shaft 15 and secures the tree stand connection device 20 to the shaft 17.

On the outer surfaces of the tree stand insert 19 is a groove 32, which is mated to a corresponding notch 33 on the interior surface of the respective halves 18, 20 of the tree stand connection device. FIGS. 4, 5, 6 This notch and groove configuration insures that the round or square tubing remains in proper position.

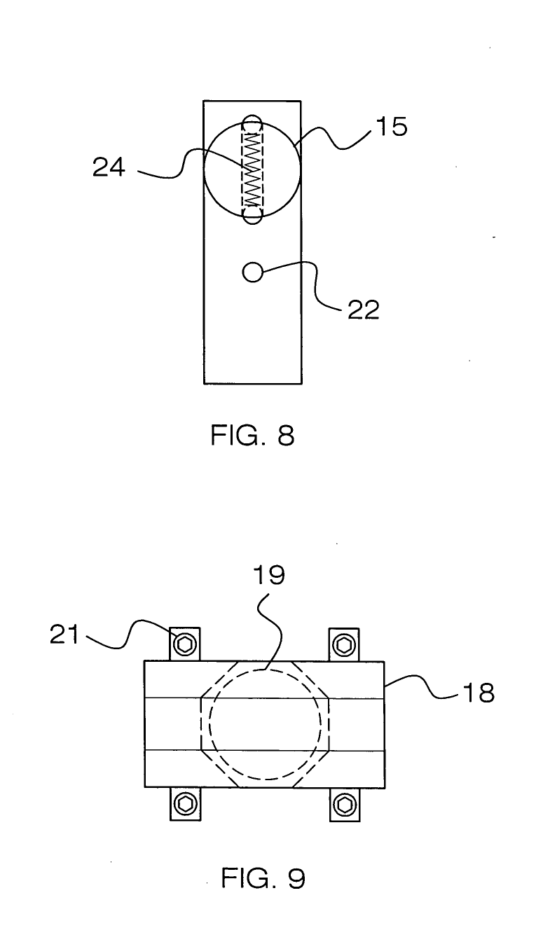

The shaft 17 will allow the quiver 8, once it is secured to the bracket 10 to rotate 360 degrees for the appropriate positioning of the quiver with the arrows 8. FIG. 1, 2 In order to ensure that the quiver 21 remains connected to the tree stand there is a hole 16 for the grommet 24, and a spring 23 provides appropriate tension for the device. FIG. 8 When the tree stand connection device shaft 17 is placed over the holes 16 a portion of the grommet will protrude through the opening 16 for that purpose and secure the device. FIG. 7 Tree stands are equipped with circular or round as well as square tubing. The insert 19 can be interchanged using square tubing 25 or round tubing 30 depending on the particular structure of the tree stand and its requirements.

While the embodiments of the invention have been disclosed, certain modifications may be made by those skilled in the art to modify the invention without departing from the spirit of the invention.

The inventor claims:

1. A device to secure a quiver of arrows to a tree stand, which is comprised of:
a. tree stand connection device;
wherein the tree stand connection device secures the device to the tree stand;
wherein the tree stand connection device assembly has a first end and a second end;
wherein a means to secure the two ends is provided;
b. tree stand insert;
wherein the tree stand insert has a first end and a second end;
wherein the tree stand insert ends are placed within the two halves of the tree stand connection;
wherein grooves are provided on the respective ends of the tree stand insert;
c. tree stand connection device shaft;
wherein the tree stand connection device shaft is attached to the first end of the tree stand connection device;
wherein a plurality of holes is provided in the tree stand connection device shaft;
d. grommet;
wherein a grommet is provided to secure the quiver shaft to the tree stand connection device;
wherein protrusions are provided on the ends of the grommet;
wherein the protrusions fit within holes in the quiver shaft and the corresponding tree stand connection device shaft;
wherein a spring provides a means to secure the protrusion in the holes;
e. quiver bracket;
wherein the quiver bracket is of predetermined size to attach the quiver to the device;
f. quiver shaft;
wherein a quiver shaft is provided;
wherein a means to secure the quiver to the quiver bracket is provided.

2. The means to connect the halves of the mounting bracket assembly as described in claim 1 are a plurality of allen screws.

3. The means to connect the halves of the mounting bracket assembly as described in claim 1 are a nut and bolt.

4. The means to secure the quiver bracket as described in claim 1 is a wing nut.
